(19) United States
(12) Patent Application Publication
(10) Pub. No.: US 2024/0313304 A1
(43) Pub. Date: Sep. 19, 2024

(54) ENERGY STORAGE DEVICE HAVING CELL WITH COATING

(71) Applicant: DEERE & COMPANY, MOLINE, IL (US)

(72) Inventor: Aneil POKHAREL, Raleigh, NC (US)

(21) Appl. No.: 18/470,533

(22) Filed: Sep. 20, 2023

Related U.S. Application Data
(60) Provisional application No. 63/490,041, filed on Mar. 14, 2023.

(51) Int. Cl. H01M 50/124; C25D 5/02; C25D 7/00; C25D 9/02; C25D 9/04; C25D 11/02; C25D 21/10; H01M 50/107; H01M 50/119; H01M 50/121; H01M 50/213; H01M 50/588; H01M 50/593

(52) U.S. Cl. CPC H01M 50/1245; C25D 5/022; C25D 7/00; C25D 9/02; C25D 9/04; C25D 11/022; C25D 21/10; H01M 50/107; H01M 50/119; H01M 50/121; H01M 50/213; H01M 50/588; H01M 50/593

(57) ABSTRACT

An energy storage device including an energy storage cell having a metal substrate or a metal sleeve. The energy storage cell includes a coating disposed on the metal substrate or metal sleeve, wherein the coating includes one of an electrolytic deposited coating, an electroless deposited coating, or an applied coating. The coating is electrically non-conductive but thermally conductive. The coated energy storage cell include an exposed positive electrode, an exposed negative electrode. A plurality of energy storage cells is located in a block having a plurality of compartments, wherein one cell of each of the plurality of energy storage cells is disposed in one of the plurality of compartments to provide an energy storage module.

### CROSS-REFERENCE TO RELATED APPLICATION

This application claims priority to U.S. Provisional Application No. 63/490,041, filed Mar. 14, 2023, entitled “Energy Storage Device Having Cell with Coating” the disclosure of which is hereby incorporated by reference in its entirety.

### FIELD OF THE DISCLOSURE

The present disclosure generally relates to an energy storage device and more particularly to an energy storage device for an electric vehicle including a plurality of energy storage cells.

### BACKGROUND

Energy storage devices, such as electric batteries in electric vehicles, may utilize active heating and/or active cooling based on desired charge and discharge currents for vehicle needs.

### SUMMARY

According to an aspect of the present disclosure, an energy storage device includes at least one energy storage cell with a coating. In embodiments, the coating is an epoxy or other material coating or the coating is a modified metal surface, such as through passivation in a non-limiting example.

In one embodiment, there is provided an energy storage device including an energy storage cell including a metal substrate or a metal sleeve, wherein the energy storage cell includes a coating disposed on the metal substrate or metal sleeve, wherein the coating includes one of an electrolytic deposited coating, an electroless deposited coating, or an applied coating.

In some implementations, the energy storage device includes wherein the one of the electrolytic deposited coating, the electroless deposited coating, or the applied coating comprises a non-conductive but thermally conductive coating.

In some implementations, the energy storage device includes wherein the applied coating includes a metal sleeve, an epoxy polymer, or a ceramic coating.

In some implementations, the energy storage device includes wherein the applied coating includes a thickness of between one-tenth of a millimeter and one millimeter.

In some implementations, the energy storage device includes wherein the one of the electrolytic deposited coating or the electroless deposited coating comprises a passivation layer.

In some implementations, the energy storage device includes wherein the energy storage cell includes a positive electrode and a negative electrode, wherein the positive electrode and the negative electrode are free of passivation film.

In some implementations, the energy storage device includes wherein the passivation layer includes a thickness of between five nanometers and fifty nanometers.

In some implementations, the energy storage device includes wherein the passivation layer of the electrolytic deposited coating results from an exposure to an electrolyte.

In some implementations, the energy storage device includes wherein the passivation layer of the electrolytic deposited coating results from chemical reduction of metal ions in an aqueous solution.

In another embodiment, there is provided a method of preparing a battery cell for use in an energy storage module having a hollow block. The method includes: identifying a type of metal of a metal substrate or a metal sleeve of the battery cell; identifying a first location of a positive electrode; identifying a second location of a negative electrode; masking the first location of the positive electrode with a first mask; masking the second location of the negative electrode with a second mask; placing the battery cell in one of an electrolyte bath or an anodizing bath; immersing the battery cell in the one of the electrolyte bath or the anodizing bath to apply an electrically non-conductive but thermally conductive film layer of a predetermined thickness to the metal; removing the battery cell from the one of the electrolyte bath or the anodizing bath after the film layer includes the predetermined thickness; and removing the first mask from the positive electrode and the second mask from the negative electrode.

In some implementations, the method includes wherein the predetermined thickness is between five nanometers and fifty nanometers.

In some implementations, the method includes wherein the immersing the battery includes immersing the battery cell for a predetermined period of time to apply the film layer of the predetermined thickness.

In some implementations, the method includes wherein the predetermined period of time is based on the type of metal or the kind of the one of the electrolyte bath or the anodizing bath.

In some implementations, the method further includes exposing the metal located beneath the film layer to provide one of an electrically conductive site or an electrical welding site.

In some implementations, the method further includes agitating the one of the electrolyte bath or the anodizing bath while immersing the battery cell.

In some implementations, the method includes wherein the electrolyte bath includes a nitric acid solution.

In a further embodiment, there is provided an energy storage module including a plurality of battery cells, wherein each of the battery cells includes metal substrate, an exposed positive electrode, an exposed negative electrode, and a coating disposed on the metal substrate, wherein the coating comprises a non-conductive but thermally conductive coating. The module includes a block including a plurality of compartments, wherein one battery cell of each of the plurality of battery cells is disposed in one of the plurality of compartments.

In some implementations, the energy storage module includes wherein each of the plurality of battery cells includes one of an electrolytic deposited coating, an electroless deposited coating, or an applied coating.

In some implementations, the energy storage module includes wherein the plurality of compartments are fluidically coupled to transfer an electrically conductive fluid between each of the plurality of compartments.

In some implementations, the energy storage device includes wherein the plurality of compartments is configured to prevent the exposed positive electrode and the exposed negative electrode from being fluidically coupled to the electrically conductive fluid.

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1 illustrates an energy storage device in accordance with embodiments of the present disclosure.

FIG. 2 illustrates a metal sleeve for an energy storage device generally rectangular in shape.

FIG. 3 illustrates a battery cell being prepared for an application of a non-conductive coating to a metal sleeve.

FIG. 4 illustrates an application of an mask to an electrode of a battery cell.

FIG. 5 illustrates a bath for treating a substrate of a battery cell to apply a non-conductive coating or film to a metal sleeve of the cell.

FIG. 6 illustrates a coated energy storage cell.

FIG. 7 illustrates a metal sleeve generally rectangular in shape having an applied non-conductive coating.

FIG. 8 illustrates an energy storage module including energy storage devices.

Like reference numerals are used to indicate like elements throughout the several figures.

### DETAILED DESCRIPTION

The present disclosure relates to cylindrical, pouch or prismatic cell batteries that use metal housings, sleeves, or both, designed to be electrically insulative, but thermally conductive, which can be used to prevent electrical conduction between the housing and a conductive cooling medium, such as a cooling liquid having conductive properties. Once such cooling liquid having conductive properties include oil. The electrically insulted cell batteries prevent arc propagation during a battery short, but enable efficient cooling of the cells using versatile coolant fluid options seen in the marketplace. The present disclosure provides a battery including a metal housing or sleeve material that is used for making cylindrical, prismatic or pouch form factors that are electrically insulative, but thermally conductive, such as for use in immersion cooled batteries in a non-limiting example. This metal substrate can be made of any suitable metals such as stainless steel or aluminum and treated during roll production, during roll manufacturing, or after roll manufacture to achieve the desired electrical and thermal properties. The metal substrate may be formed as a separate sleeve or casing around the cell or directly on the outer surface of the cell.

The metal substrate material can be treated in various ways to create an electrically insulative, but thermally conductive surface. For example, the metal canister material used in cylindrical cells can be passivated to create a surface layer that is electrically insulative but thermally conductive. The process of creating a passivation layer can be done electrolytically or via electroless process. The passivation process can be performed by exposing the metal substrate to a solution of nitric acid and sodium dichromate, among other electrolytes. The nature of these electrolytes will vary depending on the metal that is being treated. These electrolytes could be such strong acids as sulfuric acid, hydrochloric acid, or hydrofluoric acid, to name some non-limiting examples, or could be strong base materials or liquids as well. The thickness of the passivation layer can be between five (5) and fifty (50) nanometers and may be generally self-limiting due to losing electrical conductivity at the surface.

These layers can also be controlled with electrical current pulse parameters such as frequency, magnitude, and duration and could be anodic or cathodic. If done with electroless techniques, the layer can be controlled through optimization of electrolyte immersion duration. Since these passivation layers may be thin, a layer may be scratched off or otherwise selectively removed during manufacturing, if there is a desire to have localized conductive spots on the metal, such as for the purposes of improving electrical welding or creating necessary electrical pathways. Alternatively, the metal substrate can be coated with one or more thermally conductive, but electrically insulative materials, such as an epoxy polymer (with high dielectric properties) and/or a ceramic coating.

The coating can be applied using any suitable methods such as powder coating, dip coating, chemical vapor deposition (CVD) or electroplating. The metal prepared in this way can be used in any battery form factors and sizes such as cylindrical, prismatic or pouch cells and can be used for any electrode/electrolyte chemistries such as Lithium ion, Nickel cadmium, or Nickel metal hydride.

The metal sleeve, the coating, or both the metal sleeve and coating can be of any thickness optimized for the application to which the battery cells experience. In a non-limiting example, for instance, the thickness is in the range of one tenth (0.1) and one (1) millimeter.

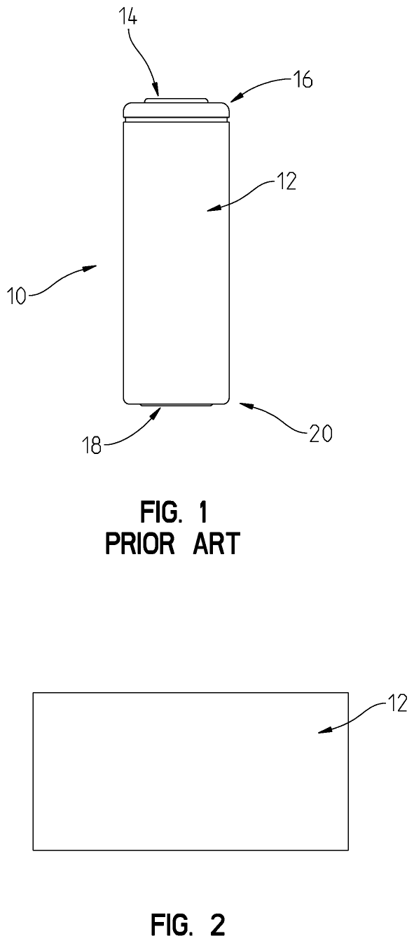

FIG. 1 illustrates an energy storage cell 10, for example a battery cell of the prior art. The cell 10 includes generally cylindrical shape having an outer surface defined by a metal substrate 12, such as a metal sleeve. The metal sleeve 12 defines a cylindrical body having a positive electrode 14 located at a first end 16 of the cell 10 and a negative electrode 18 located at a second end 20.

As illustrated in FIG. 2, the metal sleeve 12 is generally rectangular in shape and includes dimensions configured to sufficiently cover the battery components located within the metal sleeve 12 once the cell 10 is formed, as is understood by one skilled in the art. The metal sleeve 12 includes an untreated preformed cylindrical cell, a sleeve, or a metal, which could be aluminum-based, stainless steel, or another metal in certain embodiments, each of which are electrically conductive. For instance, FIG. 2 illustrates any metal foil, sheet, or roll that is not passivated or otherwise treated to be electrically non-conductive.

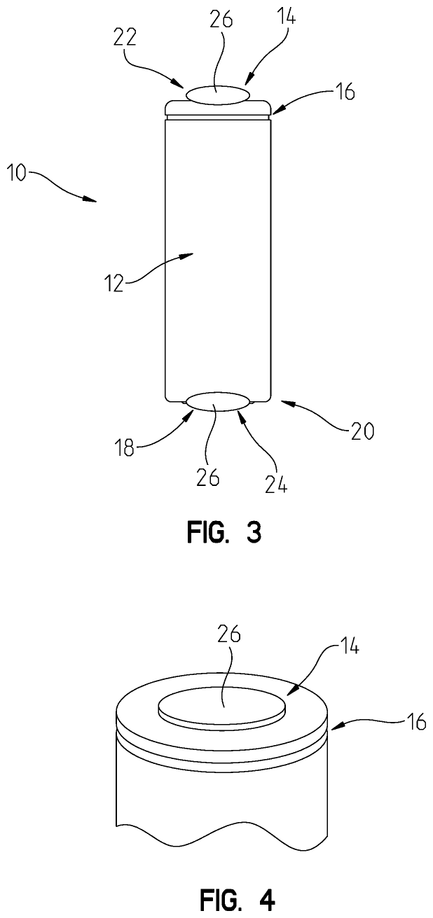

FIG. 3 illustrates the battery cell 10 being prepared to apply a non-conductive coating to the metal sleeve 12. To prevent the metal sleeve 12 from conducting electricity, a non-conductive coating is applied to the metal sleeve. To insure that the positive electrode 14 and negative electrode 18 remain exposed for electrically conductivity, the positive electrode 14 is covered with a mask 22 and the negative electrode 18 is covered with a mask 24. Each of the masks 22 and 24 is used as a cover to isolate the electrodes 14 and 18 from coming into contact with a non-conductive material that is applied to or is deposited on the metal sleeve 12. The masks prevent the electrodes from becoming non-conductive.

In one embodiment, the masks 22 and 24 include an adhesive tape 26 applied to the exposed conductive material of the electrodes. Once the non-conductive material is applied to the sleeve 12, the adhesive tape is removed. In other embodiments, the masks 24 include a liquid adhesive applied by a brush or other applicator to the electrodes to form a removable film. In different embodiments, the applied masks cover an entirety of the electrodes or only a portion of the electrodes. If only a portion of the electrodes is covered with the mask, the masked portion includes a portion sufficient to accept an electrical connection or connector once the mask is removed. For instance, the exposed portion is localized, but is sufficiently large enough to accept a welded connection for instance. FIG. 4 illustrates the application of the adhesive tape 26 to the positive electrode 14 which can be peeled from the electrode when required.

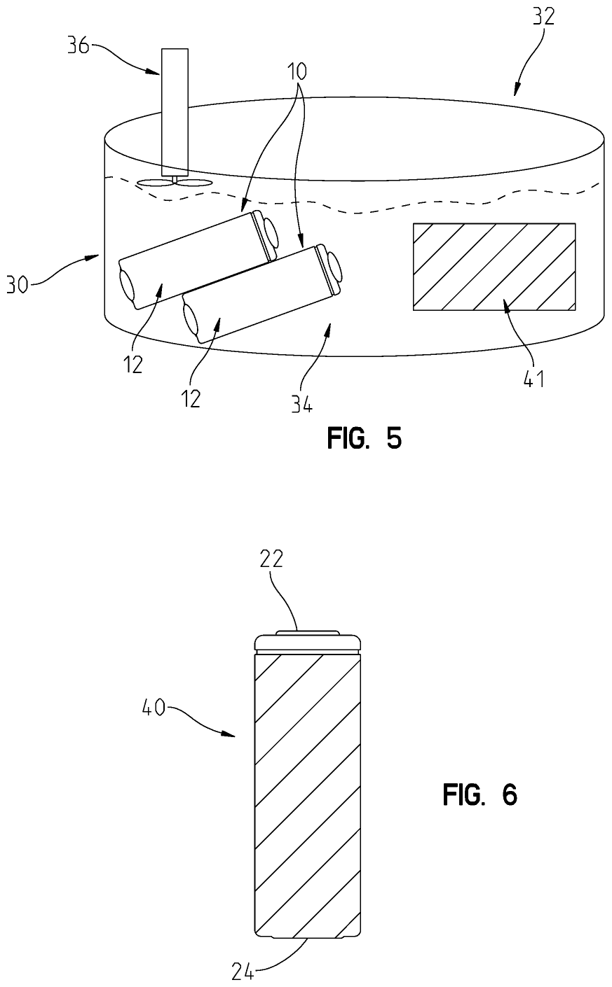

FIG. 5 illustrates a bath 30 for treating the substrate 12 of cell 10 to apply a non-conductive coating or film to the metal. The bath 30 includes a container 32 configured to hold a fluid 34. In different embodiments, the fluid is an aqueous electrolyte fluid, including water, or a non-aqueous electrolyte fluid, including an acid. In a non-limiting example, the fluid is a nitric acid or citric acid fluid having a temperature of around 40 degrees Centigrade.

Each of the energy storage cells 10 is immersed in the bath 30 for a predetermined period of time which is sufficient for the metal to oxidize and to form a layer of non-conductive film on the metal substrate 12. The cells 10, in one non-limiting example, are placed in the bath and remain there for between five-tenths (0.5) and three (3) hours for stainless steel-based metal housings. The type of electrolyte bath may vary based on the metal being treated. In one non-limiting example, the bath includes a citric acid solution with water at four (4) % to ten (10) %. In some embodiments, the fluid 34 is agitated continuously with an agitator 36. In embodiments using nitric acid, a trial may be conducted to include water from five (5) % to fifty (50) % due to more hazardous conditions and/or handling precautions. In some embodiments, the process could be made electrolytically as well, such as in a typical anodization process. In other embodiments, the fluid 34 may be altered for surface treatment of aluminum and/or in an anodization process. In other embodiments, the substrate 12 is immersed in the bath 30 prior to being used in the manufacture of a completed energy storage cell 10. In additional embodiments, the substrate 12 may be in the form of a strip of material, a coil of material, or other form, that once oxidized, is used to manufacture the energy storage cell 10. While a submersible bath 30 is illustrated, other embodiments include submersible baths that receive energy storage cells 10 that are suspended from a moving track and which move through the bath from an entry point to an exit point.

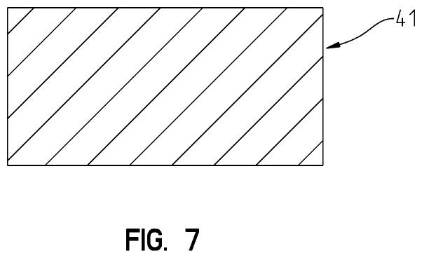

FIG. 6 illustrates a coated energy storage cell 40 having a coating resulting from the bath process of FIG. 5. Once the passivated or otherwise treated energy storage cell 40 has been treated, the cylindrical cell, the sleeve, the metal foil, the sheet, or roll, includes a layer of oxidized material which is located on the aluminum, the stainless steel, and/or other metal material used in the energy cells embodiments. The masks 22 and 24 are removed for necessary or beneficial connections. As illustrated in FIG. 7 and as shown by a cross-hatching, a blue or other color passivating film that is electrically non-conductive, but thermally conductive, is formed on the cell, metal, and/or sleeve 41. The film provides the electrical characteristics necessary to prevent electrical arc propagation from the energy storage cells and enables the use of electrically conductive fluid without creating an electrical short or generating unacceptable additional weight into the energy storage cells 10, therefore keeping within any kilowatt-hours (kWh)/gram metric target.

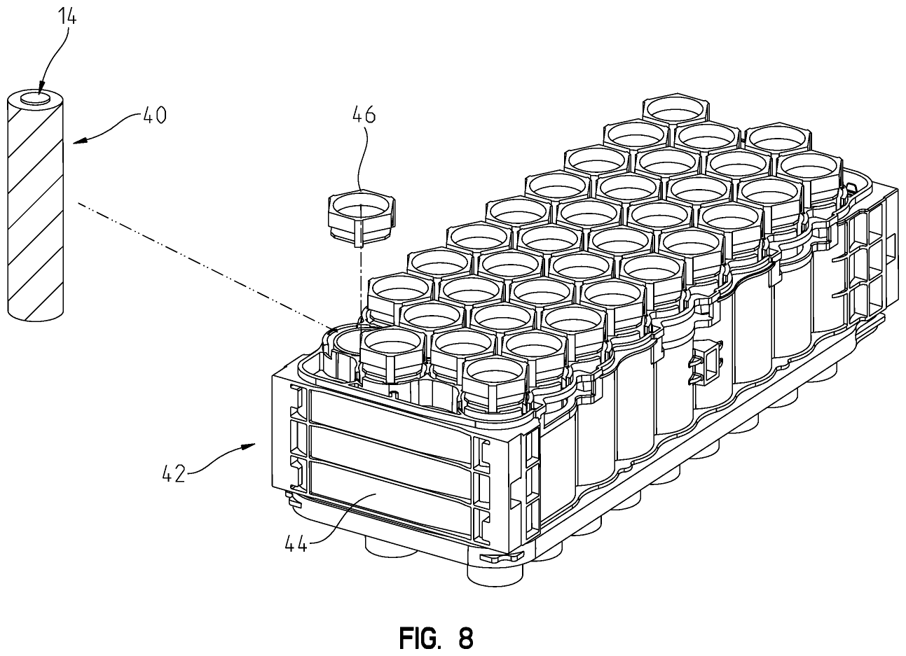

FIG. 8 illustrates an energy storage module 42 that includes a base 44 having a plurality of compartments, each of which receives a single energy storage cell 40 which has a metal surface that has been coated with the electrically non-conducting but thermally conducting exterior surface. Once each one of a plurality of the energy storage cells 30 is placed in one of the plurality of compartments, a cap 46 is coupled to the cell 40 to provide an electrical connection to charge or to discharge energy to or from each of the cells 40. A fluid source, not shown, is coupled to an inlet of the base 44 which receives the electrically conductive cooling fluid to insure a proper operating temperature of the energy storage module 42. The base 44 includes an outlet, not shown, which transfers the cooling fluid past each of the plurality of energy storage cells from the inlet to the outlet. The temperature of the fluid is heated or cooled to maintain a predetermined operating temperature of the cells. The fluid is cooled or heated as necessary and returned to the inlet to provide a cooling effect to the energy storage cells.

Without in any way limiting the scope, interpretation, or application of the claims appearing below, a technical effect of one or more of the example embodiments disclosed herein is providing a cell and/or energy storage device that is electrically insulative but thermally conductive surfaces to enable the use of any kind of cooling fluid in larger battery modules or packs including a plurality of modules. The cooling fluid can be conductive or non-conductive or any viscosity most suitable for the application. Non-limiting examples of some conductive coolants are water, aqueous glycol, or oil-based liquids. The unique property of the coated metal prevents electrical arching and propagation during a battery short and ensures safe and efficient cooling of the battery pack. Manufacturing processes can be optimized such that the coated passivation layer can be scratched off using lasers or ultrasonic methods to provide one or more localized conductive spots for the purpose of necessary electrical pathways and for welding. In another embodiment, the metal surface can be prepared in upstream manufacturing processes before a battery specific form factor is stamped for jelly roll insertion.

As used herein, “e.g.” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. An energy storage device comprising:
an energy storage cell including a metal substrate or a metal sleeve, wherein the energy storage cell includes a coating disposed on the metal substrate or metal sleeve, wherein the coating includes one of an electrolytic deposited coating, an electroless deposited coating, or an applied coating.

2. The energy storage device of claim 1 wherein the one of the electrolytic deposited coating, the electroless deposited coating, or the applied coating comprises a non-conductive but thermally conductive coating.

3. The energy storage device of claim 2 wherein the applied coating includes a metal sleeve, an epoxy polymer, or a ceramic coating.

4. The energy storage device of claim 3 wherein the applied coating includes a thickness of between one-tenth of a millimeter and one millimeter.

5. The energy storage device of claim 2 wherein the one of the electrolytic deposited coating or the electroless deposited coating comprises a passivation layer.

6. The energy storage device of claim 5 wherein energy storage cell includes a positive electrode and a negative electrode, wherein the positive electrode and the negative electrode are free of passivation film.

7. The energy storage device of claim 6 wherein the passivation layer includes a thickness of between five nanometers and fifty nanometers.

8. The energy storage device of claim 7 wherein the passivation layer of the electrolytic deposited coating results from an exposure to an electrolyte.

9. The energy storage device of claim 7 wherein the passivation layer of the electrolytic deposited coating results from chemical reduction of metal ions in an aqueous solution.

10. A method of preparing a battery cell for use in an energy storage module having a hollow block, the method comprising:
identifying a type of metal of a metal substrate or a metal sleeve of the battery cell;
identifying a first location of a positive electrode;
identifying a second location of a negative electrode;
masking the first location of the positive electrode with a first mask;
masking the second location of the negative electrode with a second mask;
placing the battery cell in one of an electrolyte bath or an anodizing bath;
immersing the battery cell in the one of the electrolyte bath or the anodizing bath to apply an electrically non-conductive but thermally conductive film layer of a predetermined thickness to the metal;
removing the battery cell from the one of the electrolyte bath or the anodizing bath after the film layer includes the predetermined thickness; and
removing the first mask from the positive electrode and the second mask from the negative electrode.

11. The method of claim 10 wherein the predetermined thickness is between five nanometers and fifty nanometers.

12. The method of claim 10 wherein the immersing the battery includes immersing the battery cell for a predetermined period of time to apply the film layer of the predetermined thickness.

13. The method of claim 12 wherein the predetermined period of time is based on the type of metal or the kind of the one of the electrolyte bath or the anodizing bath.

14. The method of claim 10 further comprising exposing the metal located beneath the film layer to provide one of an electrically conductive site or an electrical welding site.

15. The method of claim 10 further comprising agitating the one of the electrolyte bath or the anodizing bath while immersing the battery cell.

16. The method of claim 10 wherein the electrolyte bath includes a nitric acid solution.

17. An energy storage module comprising:
a plurality of battery cells, wherein each of the battery cells includes metal substrate, an exposed positive electrode, an exposed negative electrode, and a coating disposed on the metal substrate, wherein the coating comprises a non-conductive but thermally conductive coating;
a block including a plurality of compartments;
wherein one battery cell of each of the plurality of battery cells is disposed in one of the plurality of compartments.

18. The energy storage module of claim 17 wherein each of the plurality of battery cells includes one of an electrolytic deposited coating, an electroless deposited coating, or an applied coating.

19. The energy storage module of claim 18 wherein the plurality of compartments are fluidically coupled to transfer an electrically conductive fluid between each of the plurality of compartments.

20. The energy storage module of claim 19 wherein the plurality of compartments is configured to prevent the exposed positive electrode and the exposed negative electrode from being fluidically coupled to the electrically conductive fluid.
